(19) United States
(12) Patent Application Publication
(10) Pub. No.: US 2025/0242750 A1
(43) Pub. Date: Jul. 31, 2025

(54) VEHICULAR BACKUP SAFETY SYSTEM

(71) Applicant: Ross Blankenship100, Edwards, CO (US)

(72) Inventor: Ross Blankenship100, Edwards, CO (US)

(21) Appl. No.: 18/424,812

(22) Filed: Jan. 28, 2024

(51) Int. Cl. B60Q 1/50; B60Q 1/22; B60Q 1/26

(52) U.S. Cl. CPC B60Q 1/50; B60Q 1/22; B60Q 1/2603

(57) ABSTRACT

The invention is a vehicular backup safety system that provides a reflected light pattern on a horizontal surface area, on the ground, behind a vehicle that is placed into reverse mode.

### TECHNICAL FIELD

The invention is a system for adding safety to a vehicle backing out of a parking-lot space and avoiding collisions with another vehicle moving transversely through the aisle.

### BACKGROUND OF INVENTION

One of the factors that causes a significant degree of vehicle collisions is the failure to see a vehicle backing out of a parking lot parking space into an aisle while a second vehicle is traveling toward the first vehicle in that aisle.

In a situation where a parked vehicle is blocked from view by another parked vehicle, and is attempting to reverse out of a parking slot into an aisle, until a driver of a second vehicle moving down that aisle sees the first vehicle in motion, there is a significant likelihood of the vehicle in the aisle colliding with the rear end of the first vehicle, or the first vehicle colliding with side of the second vehicle.

The likelihood of such collisions increases during the day under bright daylight conditions. The car in the aisle cannot be seen by the driver reversing out of the slot, and the driver in the aisle car cannot readily see either the brake lights or backup lights because they are transverse to his position and weakened by ambient light.

Under darkness conditions, it is a bit easier to see the reversing vehicles brake lights, but since brake lights and backup lights are focused essentially horizontal to the parking lot surface, the driver of the aisle car would have to be looking to the right in order to see either light, and could be unlikely to see either if looking straight ahead.

For decades, vehicles have had backup lights that illuminate when a vehicle is in reverse gear and extinguish when out of reverse gear. These lights, however, are intended to illuminate the area behind the vehicle but not the ground behind the vehicle. Brake lights, too, are not intended to focus light downward and backward, just backward.

Thus, such accidents are most likely to happen during bright daylight when aisle-car drivers cannot detect that a parked car is attempting to reverse out of the parking slot.

### BRIEF DESCRIPTION OF INVENTION

The invention is a system operative to turn on and off with a vehicle's installed backup lights but operative to project a highly visible light pattern in an area behind the reversing vehicle.

High-intensity light sources and lensing produces converging beams of light that are focused out and down behind the reversing vehicle. The intensity of light projected onto the ground behind the reversing vehicle extends out a distance that would enable it to illuminate the surface of the ground in the aisle before the vehicle begins moving. Thus, as soon as the vehicle has been put in reverse gear, and even before it begins moving, its backup safety system will make it apparent to a driver of a car moving along the aisle that a car is in the process of reversing out of its spot.

The backup safety system has sufficient high-intensity light sources to ensure that the illuminated surface area has sufficient light intensity to be seen in the brightest daylight conditions.

An added capability is ongoing detection of the light intensity by a sensor which continuously conveys intensity data to a light-source control system such that a predetermined level of intensity is maintained under all light conditions. Using the sensor data, the control system will either increase or decrease high-intensity light output to maintain that predetermined intensity level.

### BRIEF DESCRIPTION OF DRAWINGS

FIG. 1 shows a first vehicle reversing out of a parking slot, during daylight conditions, while a second vehicle is traveling transversely down the aisle toward the first vehicle.

FIG. 2 shows a first vehicle reversing out of a parking slot, during darkness conditions, while a second vehicle is traveling transversely down the aisle toward the first vehicle.

FIG. 3 depicts a case where the first vehicle in FIG. 1 is equipped with the backup safety system illuminating the surface behind it during daylight.

FIG. 4 depicts a case where the first vehicle in FIG. 2 is equipped with the backup safety system illuminating the surface behind it during nighttime conditions.

FIG. 5 shows a front view of an embodiment of the high-intensity light source subsystem of the backup safety system.

FIG. 6 shows a side view of the embodiment of the high-intensity light source subsystem of the backup safety system.

FIG. 7 shows the embodiment of FIG. 6 illuminating the surface area.

FIG. 8 shows a rear view of a vehicle with the safety system installed and the juxtaposition of vehicle and the illuminated surface area.

FIG. 9 shows the subsystems that comprise the backup safety system.

FIG. 10 is a flow diagram that shows a method embodiment for maintaining essentially constant reflected light intensity from the illuminated surface area.

### DETAILED DESCRIPTION OF INVENTION

Statistics show that one cause of frequent, non-fatal, accidents are collisions between vehicles moving along a parking-lot aisle with vehicles reversing out of parking spaces into that aisle.

In general, with a vehicle aside the reversing vehicle and blocking the view of the driver of the aisle vehicle, the aisle-vehicle driver will not see the reversing vehicle until its rear end has moved beyond the vehicle aside it.

During daylight, especially on bright days, the detection of brake light or backup light on the reversing vehicle, by the driver in the aisle vehicle, is difficult. The lights are aimed essentially horizontal and rearward, a direction that is transverse to the aisle drivers line of sight. Even under darkness conditions, although the brake lights and backup lights are more detectable against ambient light, they are still aimed horizontally and transverse to the aisle-car driver's line of sight.

If a reversing vehicle, though still blocked from view by an intervening parked vehicle, could indicate to aisle-car drivers that it is reversing out of its parking spot, the aisle-car drivers would have more warning and time to react, therefore significantly preventing such accidents.

The problem to overcome is that light aimed transversely to a line of sight is difficult to detect. It would be easier to detect if it was projected onto a surface that reflects the light in many different directions and angles.

The backup safety system invention does just that. Only when a vehicle is reversing, in sync with the regular backup lights, the backup safety system produces and focuses a high-intensity light pattern onto the ground behind a reversing vehicle such that it will jut out far enough to be seen before the backing-up vehicle even begins to move. In essence, as soon as it is placed in reverse gear, the backup safety system illuminates an area of ground, behind the vehicle, and far enough out to be unblocked by any intervening parked vehicle.

Therefore, an aisle-car driver will see, on the ground, essentially extending into the aisle, a distinctive illuminated area that indicates a vehicle in the process of reversing out of its parking space.

If the illumination was fixed by a constant number of light sources and intensity, it would be more visible at night than during the day because of the effect of ambient light. To overcome that, the backup safety system is operative to produce a readily discernable illuminated area during daylight ambient light, and maintain that same level of reflected intensity under darkness conditions. It does so by creating a closed loop wherein a light-source control subsystem receives reflected light intensity data from the illuminated area, and controls the number of sources and intensity to maintain an essentially constant reflected light intensity regardless of ambient light.

The following description, in combination with the drawings, is meant to provide a more detailed description of the invention and its utility.

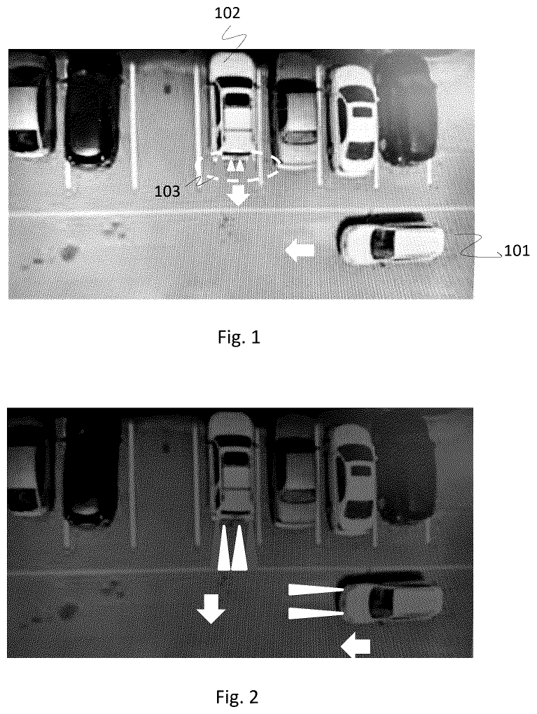

FIG. 1 shows an aisle car (101) traveling to the left along an aisle while parked car (102) begins to reverse out of its parking space. It is daytime, so the aisle car's headlights are off, and the brake light and backup light (103) of the parked vehicle are both pointed transverse to the aisle-car drivers line of vision, and muted in discernibility by the ambient daylight.

In FIG. 2, the same two vehicles are now doing the same as before but under darkness conditions. The aisle-vehicle's headlights are on, and the now reversing vehicle's brake lights and backup light appear brighter in contrast to the ambient light, but are still pointed essentially horizontal and transverse to the aisle-car driver's line of vision.

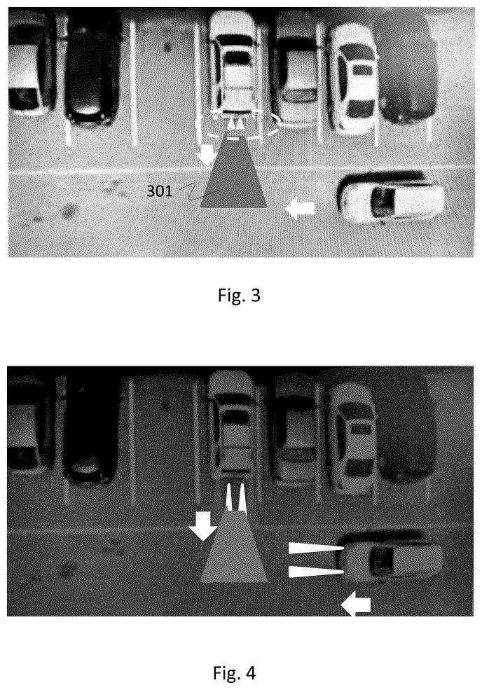

In FIG. 3, the same scenario as in FIG. 1 is duplicated but the reversing vehicle, equipped with the backup safety system, is projecting a high-intensity light pattern (301) onto the ground behind the vehicle. Note also that area 301 extends beyond the vehicle parked to the reversing-vehicle's right. As such, even before that reversing vehicle begins moving, the driver in the aisle car is able to see the pattern illuminated on surface extending into the aisle.

FIG. 4 shows the reversing vehicle and aisle vehicle under nighttime conditions. Here the aisle vehicle has its headlines illuminated, and the brake light and backup light appear brighter, but neither the headlights nor brake lights nor backup lights are focused down and to the rear, so they will hardly affect the discernibility of the backup safety system's surface pattern.

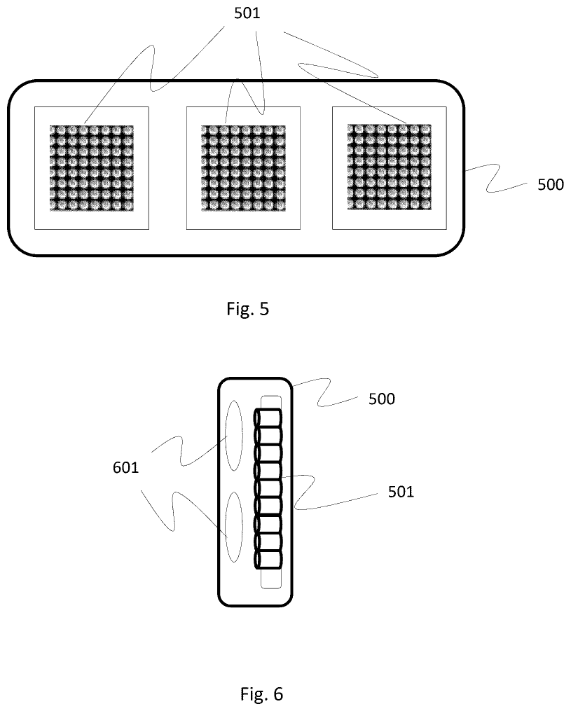

FIG. 5 shows an embodiment of the invention comprising an enclosure (500) and a plurality of light sources (501) from a view toward the reversing vehicle's back end.

FIG. 6 shows the embodiment of FIG. 5 from a side view wherein the light source output passes through a lensing system (601) operative to combine the beams and focus them downward so as to produce a reflected light pattern on the ground to the rear of the vehicle.

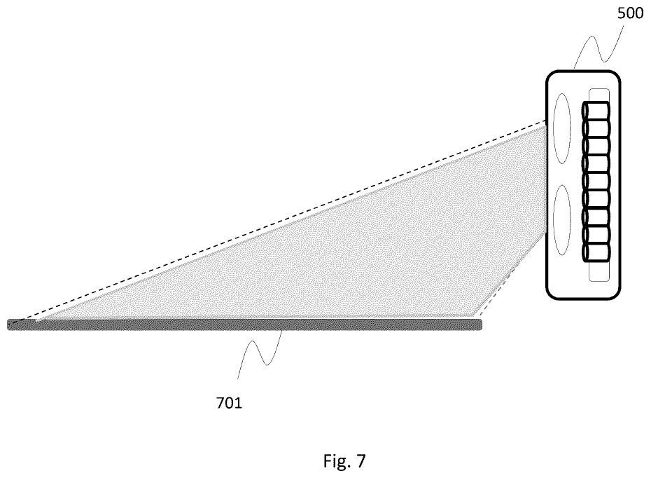

FIG. 7 shows the same view as FIG. 6 further illustrating how the lensing subsystem produces the light pattern (701) on the horizontal surface.

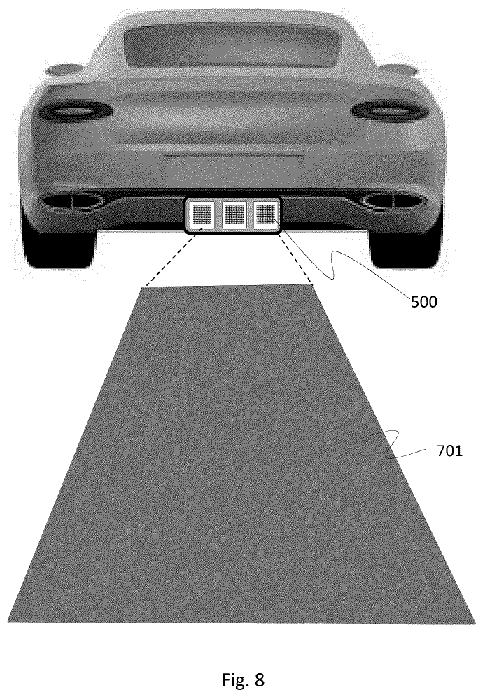

In FIG. 8, the backup safety system embodiment (500) is installed on the back end of the vehicle and produces the light pattern (701) on the ground behind the vehicle.

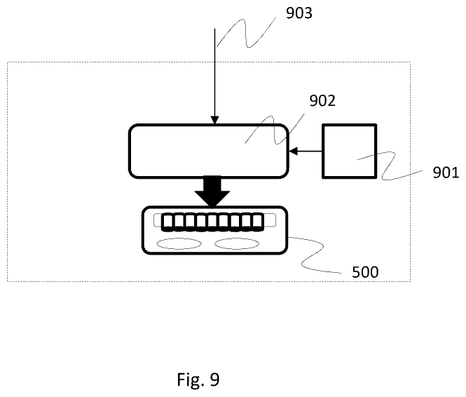

FIG. 9 depicts an embodiment of the backup safety system comprising the light-source/lensing subsystem (500) with a lighting-control subsystem (902) receiving continuous light-intensity data from a sensor (901) when the system is turned on by the backup-light power connection (903).

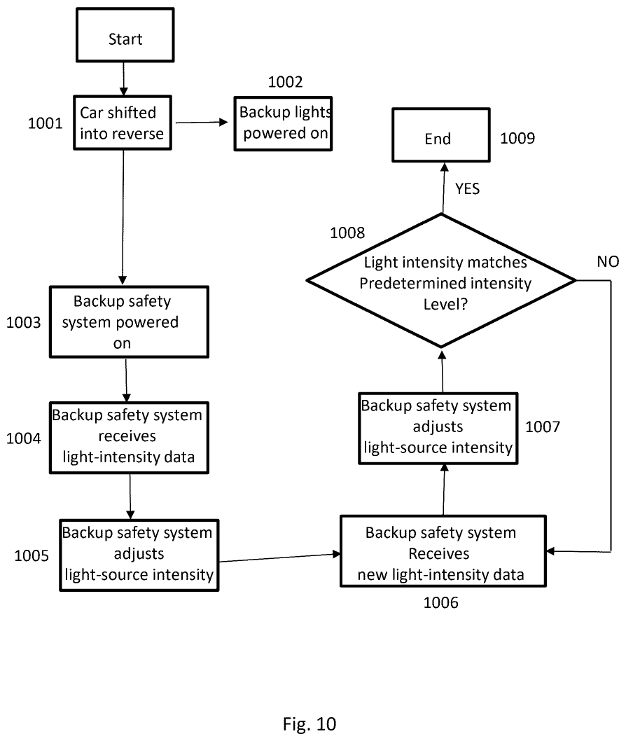

FIG. 10 is a flow diagram of the sequence of steps that occur once the vehicle equipped with the embodiment of the backup safety system is placed in reverse mode (1001), which powers up the backup lights (1002), which simultaneously powers up the backup safety system (1003). As shown, the backup safety system receives light-intensity data from a sensor (1004), prompting the light control system to adjust light intensity output (1005), which causes the sensor data to change and new data is conveyed (1006). This prompts a light-intensity adjustment (1007), creating a closed-loop where adjustments and intensities are evaluated conditionally (1008) until the measured intensity is essentially the same as a predetermined intensity level. Once the intensity measured is essentially the same as the predetermined intensity level, no further adjustments are made.

The drawings and description are exemplary and should not be read as limiting the scope of the invention. It may be implemented as an after-market solution that is adapted to existing vehicles. It may be designed into new cars by original car makers and contained within existing housings. The various subsystems are shown and described as separate subsystems, but the invention could also be modularized into a single module.

The light-source technology may be any technology capable of providing sufficient reflected light intensity over the intended horizontal surface area consistent with vehicular power budgets, overall physical size, and so on.

What is claimed is:

1. A vehicular backup safety system comprising:
a plurality of high-intensity light sources;
a plurality of lenses;
a light-intensity sensor;
a high-intensity-light-source control subsystem; and
a vehicle backup-light power input.

2. A claim as in claim 1 wherein:
the plurality of high-intensity-light sources produce a diverging beam of high-intensity light.

3. A claim as in claim 1 wherein:
the plurality of lenses are operative to merge the diverging beam of high-intensity light so as to illuminate a predetermined horizontal surface area with essentially the same reflective light intensity; and
the predetermined horizontal surface area is to the rear of a vehicle and impinges on a surface upon which the vehicle's wheels are supported.

4. A claim as in claim 1 wherein:
the light-intensity sensor is operative to receive reflected light from the predetermined horizontal surface area and convey intensity metric data to the high-intensity-light-source control subsystem.

5. A claim as in claim 1 wherein:
the high-intensity-light-source control subsystem receives continuous intensity metric data from the light-intensity sensor; and
the light-intensity-light-source control subsystem compares the metric data received from the light-intensity sensor to the predetermined intensity value and adjusts the high-intensity-light-source intensity until the predetermined intensity value is sensed.

6. A claim as in claim 1 wherein:
vehicle backup light power turns on the backup safety system whenever a vehicle is placed in reverse gear, and turns off the backup safety system whenever the vehicle is placed in any non-reverse gear.

7. A method of use comprising:
turning on a car engine, and, when placing it in reverse gear;
receiving power from a backup light power input:
receiving by a high-intensity-light control subsystem, from a light-intensity sensor a metric of light intensity sensed in a predetermined horizontal area to the rear of the vehicle;
comparing the light-intensity metric received by the high-intensity-light control subsystem to a predetermined value of light intensity and:
if below the predetermined value, then increasing the backup safety system light intensity;
if above the predetermined value, then decreasing the backup safety system light intensity; and
when intensity metric essentially equals the predetermined intensity value, making no further adjustments in light intensity.
